(19) United States
(12) Patent Application Publication
(10) Pub. No.: US 2016/0231219 A1
(43) Pub. Date: Aug. 11, 2016

(54) METHOD OF DETECTING FLOW STATUS IN AN OLEFIN HEATER TUBE

(71) Applicant: SHELL OIL COMPANY, Houston, TX (US)

(72) Inventor: Scott Evan PENDEGRASS, League City, TX (US)

(21) Appl. No.: 15/022,848

(22) PCT Filed: Sep. 11, 2014
(86) PCT No.: PCT/US14/55119

§ 371 Date: Mar. 17, 2016

Related U.S. Application Data
(60) Provisional application No. 61/880,245, filed on Sep. 20, 2013.

(51) Int. Cl. G01N 11/04; G01N 17/00; G01M 3/28

(52) U.S. Cl. CPC G01N 11/04; G01M 3/2815; G01N 17/008

(57) ABSTRACT

A method of indicating flow status of a first of a plurality of tubes of an olefin heater includes obtaining a set of pressure measurements from the tube over a period of time; determining a standard deviation of the tube, based on the set of measurements; obtaining a second set of pressure measurements from the tube over a second period of time; determining a second standard deviation of the tube, based on the second set of measurements; comparing the standard deviation and the second standard deviation to get a deviation change; determining an overall standard deviation of the plurality of tubes; determining whether the deviation change differs from the overall standard deviation by more than a predetermined limit; and responsive to a determination that the deviation change differs from the overall standard deviation by more than the predetermined limit, generating output indicating a flow status of the tube.

### FIELD OF THE INVENTION

The invention relates to a method of detecting flow status in an olefin heater tube.

### BACKGROUND

Pyrolysis or steam cracking is used to manufacture olefins from large hydrocarbon molecules. A reaction takes place in tubes within a fired furnace or olefin heater. Coke formation or plugging of the tubes can lead to increased fuel consumption, reduced throughput, and unscheduled maintenance.

One method of detecting plugging is to monitor the temperature of the tubes. However, the outlet temperatures of the tubes are subject to variations caused by firing problems in the furnace.

In the field fluidic catalytic cracking, attempts to detect fouling in lines have included obtaining pressure readings to detect pressure changes indicative of fouling. For example, Emerson Process Management and the ExxonMobil Research and Engineering group have tested a system using pressure transmitters in refinery operations as summarized in Szanyi et al., “Diagnostic capabilities of Foundation™ fieldbus pressure transmitters in refinery operations,” which is hereby incorporated by reference.

However, due to the level of noise present in an olefin heater, the use of pressure readings to detect pressure changes in the tubes may not be optimal. In the tubes of the olefin heater, individual pressure readings can vary widely. Thus, numerous pressure readings may be necessary to ensure that any measured variance is caused by plugging and not by noise in the system. Further, some degree plugging may occur in one of a number (e.g., 20) tubes, causing flow to bypass the plugged area in favor of another area. Such bypass may prevent detection via pressure change until the plugging is extensive enough to be considered significant. Similarly, detection of pressure change indicative of a leak may require numerous readings to ensure that variance is due to a leak and not to noise in the system, and may not detect leaks until they become significant. While detection of such significant changes may prevent a catastrophic failure, waiting for a significant change may necessitate suspension of operations to remediate the problem, which can be time consuming and costly.

### SUMMARY OF THE INVENTION

In one embodiment, a method of indicating flow status of a first tube of a plurality of tubes of an olefin heater is provided. The method includes obtaining a first set of pressure measurements from the first tube over a period of time. The method also includes determining a first standard deviation of the first tube, based on the first set of pressure measurements. The method includes obtaining a second set of pressure measurements from the first tube over a second period of time. Additionally, the method includes determining a second standard deviation of the first tube, based on the second set of pressure measurements. The method includes comparing the first standard deviation and the second standard deviation to get a deviation change. The method also includes determining an overall standard deviation of the plurality of tubes. The method further includes determining whether the deviation change differs from the overall standard deviation by more than a predetermined limit. The method includes, responsive to a determination that the deviation change differs from the overall standard deviation by more than the predetermined limit, generating output indicating a flow status of the first tube.

In another embodiment a method includes obtaining a noise parameter of a first tube of a plurality of tubes of an olefin heater. The method also includes obtaining a noise parameter of the plurality of tubes. The method includes using the noise parameter of the first tube and the noise parameter of the plurality of tubes, determining whether a flow status of the first tube is consistent with plugging, consistent with a leak, or consistent with normal operation.

In one embodiment, a system for indicating flow status of a first tube of an olefin heater is provided. The system includes a first sensor configured to periodically measure pressure of the first tube and transmit the periodic pressure measurements to a control system. The system includes a second sensor configured to periodically measure pressure of a second tube and transmit the periodic pressure measurements to the control system. The system includes a third sensor configured to periodically measure pressure of a third tube and transmit the periodic pressure measurements to the control system. The system also includes a control system. The control system is configured to receive the periodic pressure measurements from the first sensor. The control system is also configured to calculate a first standard deviation change, based on pressure measurements from the first sensor over a period of time. The control system is configured to receive the periodic pressure measurements from the second sensor. Additionally, the control system is configured to calculate a second standard deviation change, based on pressure measurements from the second sensor over the period of time. The control system is also configured to receive the periodic pressure measurements from the third sensor. The control system is configured to calculate a third standard deviation change, based on pressure measurements from the third sensor occurring over the period of time. The control system is also configured to calculate an overall standard deviation, based on the periodic pressure measurements from the first sensor, the second sensor, and the third sensor. The control system is configured to determine whether the first standard deviation change differs from the overall standard deviation by more than a predetermined limit Additionally, the control system is configured to generate an output indicating a flow status of the first tube, based on the determination of whether the first standard deviation change differs from the overall standard deviation by more than the predetermined limit

### BRIEF DESCRIPTION OF THE FIGURES

FIG. 1 illustrates an embodiment of a method for determining a flow status of a tube in an olefin heater.

FIG. 2 illustrates a schematic view of an olefin heater and associated elements.

FIG. 3 illustrates an embodiment of a method where flow status is provided for two tubes.

FIG. 4 illustrates a process flow of a control system, according to an exemplary embodiment.

### DETAILED DESCRIPTION

Olefin heaters may be designed to meet particular design criteria. Some exemplary design criteria for olefin heaters are set forth in KLM Technology Group, “Olefin Furnace (Engineering Design Guideline),” July 2012, and Tham, “Pyrolysis Furnace,” which are hereby incorporated by reference. Any design of an olefin heater may benefit from the methods of the present disclosure. In particular, it may be useful to use the methods for early detection of plugging or a leak to allow for remediation prior to the flow status change being significant. Moreover, feedback on which tube is plugged and when may allow for improved design and/or operational changes.

Generally, measuring the noise may provide information about the flow status of a particular tube within an olefin heater having many tubes. More particularly, standard deviations of pressure measurements may be determined for each of the tubes within the olefin heater over a period of time. Each of those standard deviations may be compared with an overall standard deviation to determine whether the individual standard deviation indicates an outlier. If an outlier is detected in only one of the tubes, an indication of change in that tube may be indicated. The process may be repeated over multiple time periods such that flow status changes can be readily and quickly detected in any individual tube as well as in the group of tubes as a whole. Additionally, if the overall standard deviation changes more than a threshold amount, an indication of change outside the furnace may be indicated. Thus, when the standard deviation of the particular tube changes for a reason unrelated to flow through the particular tube (e.g., an additional machine starting up downstream of the heater), it is expected that the overall or combined standard deviation would also change, resulting in the deviation change of the particular tube and the combined deviation changing by similar amounts. Thus, unless the deviation change of the particular tube exceeds the combined deviation change by more than a predetermined threshold amount or limit, it may be assumed that the change is unrelated to the particular tube, but is instead caused by a systematic issue. However, when flow status of that particular tube changes, it is expected that the standard deviation of that particular tube will change relative to the overall standard deviation.

By comparing standard deviations, rather than primary measurements, the effects of noise in the system are no longer an impediment to measurements but instead may be used to determine condition of the system. Thus, rather than attempting to filter out the noise effects, the present disclosure uses the noise to determine what is occurring in the system. Accordingly, as compared with other methods, fewer measurements may be needed to provide an accurate indication of a change. Thus, a small set of measurements might be enough to indicate an event. For example, a change in the standard deviation of pressure measurements of a particular tube may indicate a change of flow through the particular tube. An increase of the standard deviation of the particular tube, relative to an overall standard deviation of a heater, may be indicative of a leak of the particular tube. Similarly, a decrease of the standard deviation of the particular tube, relative to the overall standard deviation of the heater, may be indicative of plugging of the particular tube. Finally, a substantially constant standard deviation of the particular tube, relative to the overall standard deviation of the heater, may be indicative of normal operating conditions of the particular tube.

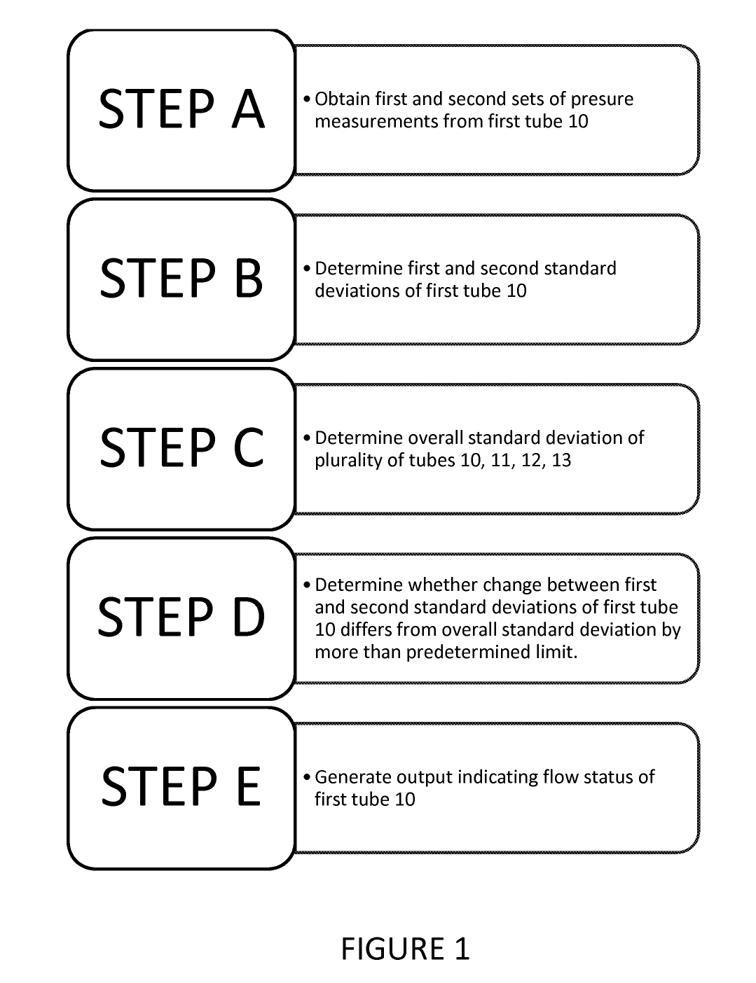

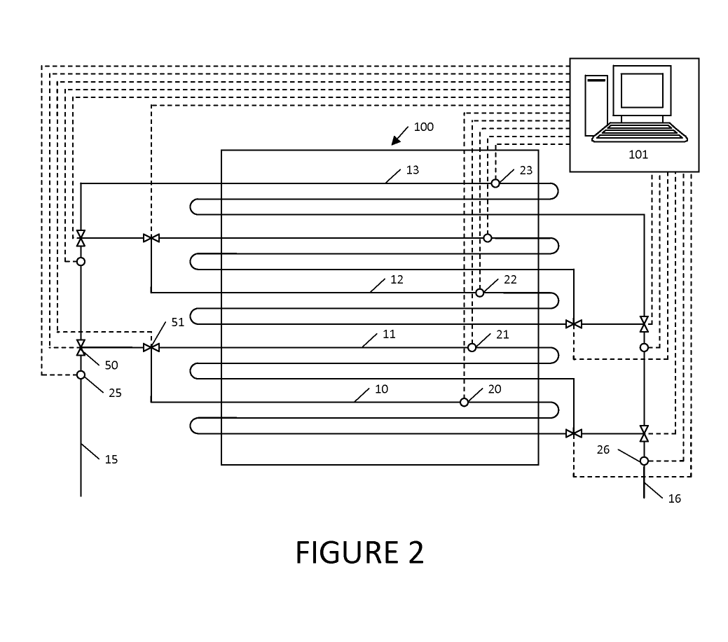

Referring now to FIG. 1, step A may include, over a period of time, measuring a set of pressure readings of a first tube 10 of a plurality of tubes 10, 11, 12, 13 of an olefin heater 100. Referring to FIG. 2, a first sensor 20 may be used to obtain a first set of pressure measurements from the first tube 10 in the olefin heater 100 over a first period of time, and a second set of pressure measurements over a second period of time. The first set of pressure measurements may be used to calculate a first standard deviation of the individual values of the frequency measurements of the first tube 10, and the second set of pressure measurements may be used to calculate a second standard deviation of the individual values of the frequency measurements of the first tube 10. Then, the first and second standard deviations may be compared to provide a deviation change over the period of time between the first period of time and the second period of time. Thus, a deviation change of the first tube 10 may be determined based on a set of pressure measurements over a first and second period of time. The first tube 10 may be one of the plurality of tubes that includes the first tube 10, a second tube 11, a third tube 12, and any of a number of other tubes (e.g., 20 tubes, 30 tubes, or 40 tubes) until an nth tube 13. The plurality of tubes 10, 11, 12, 13 may each have a respective sensor 20, 21, 22, 23. The sensors 20, 21, 22, 23 may be attached via weld and may measure frequency of the corresponding tubes 10, 11, 12, 13. The sensors 20, 21, 22, 23 may be pressure transmitters. The sensors 20, 21, 22, 23 may transmit sensed values to a control system 101 either via hard wired connections or wirelessly. When a wireless transmission is selected, the sensors 20, 21, 22, 23 may be battery powered. The first sensor 20 may sense a first pressure of the first tube 10 and transmit that measured pressure to the control system 101, and the control system 101 may store the pressure in a database, along with subsequent pressure measurements sensed and transmitted in the same manner. Similarly, the other sensors 21, 22, 23 may sense the pressures of the other tubes 11, 12, 13 over the period of time and transmit those measured frequencies to the control system 101 which may store those frequencies in the database. The pressures of the tubes 10, 11, 12, 13 may be sensed near startup of the olefin heater 100, or at any other point in time at which a flow condition is expected to change, or is otherwise desirably monitored. Thus, pressure measurements may be sensed or measured any time the olefin heater 100 is operating normally. Further, even if flow status is thought to have changed, pressure measurements may be measured when detection of additional change is desirable. Additionally, the pressure measurements may not all be measured simultaneously. Rather, so long as operational conditions are thought to remain at least somewhat constant, pressure measurements may be taken at different times within the constant operation.

Referring again to FIG. 1, step B may include determining a first standard deviation of the first tube 10 and determining a second standard deviation of the first tube 10. The control system 101 may retrieve the stored measurements from the first sensor 20 and calculate a standard deviation value for the group of measurements taken over the period of time. The control system 101 may then store the first and second standard deviations of the first tube in the database or otherwise. The standard deviations of the first tube 10 may each be a standard deviation of pressure measurements taken over a particular period of time. Alternatively, the first standard deviation of the first tube 10 may represent the pressure measurements associated with another point in time, so long as the same operational conditions are present as at the time of the first standard deviation of the first tube 10.

Referring again to FIG. 1, step C may include determining an overall standard deviation of the plurality of tubes 10, 11, 12, 13. The overall standard deviation of the plurality of tubes 10, 11, 12, 13 may correspond to the same period of time as the first standard deviation of the first tube 10, or may correspond to the period of time of the second standard deviation of the first tube 10, or even the combined period including both the first and second periods of time. Alternatively, the overall standard deviation of the plurality of tubes 10, 11, 12, 13 may represent the standard deviation of the plurality of tubes 10, 11, 12, 13 over another period of time, so long as the same operational conditions are present as at the time of the first standard deviation of the first tube 10. The overall standard deviation of the plurality of tubes 10, 11, 12, 13 may be obtained by calculation by the control system 101 or otherwise. If each of the plurality of tubes has a corresponding sensor and if measurements have already been obtained from those sensors, then obtaining the overall standard deviation of the plurality of tubes 10, 11, 12, 13 may involve taking standard deviation values for each of the plurality of tubes 10, 11, 12, 13, and conducting standard deviation calculation on those values to get the overall standard deviation of the plurality of tubes 10, 11, 12, 13. If measurements have not already been obtained from the sensors, obtaining the overall standard deviation of the plurality of tubes 10, 11, 12, 13 may include measuring pressure values of each of the tubes, including the first tube 10 and the additional tubes 11, 12, 13 and conducting a standard deviation calculation on those values to get the overall standard deviation overall standard deviation of the plurality of tubes 10, 11, 12, 13. Those measurements may be transmitted to the control system 101 and stored or otherwise used. The control system 101 may perform the standard deviation calculation based on the stored individual pressure measurements to obtain the overall standard deviation of the plurality of tubes 10, 11, 12, 13. Alternatively, the control system 101 may perform the standard deviation calculation based on the stored standard deviation values of the individual tubes 10, 11, 12, 13 to obtain the overall standard deviation of the plurality of tubes 10, 11, 12, 13. The control system 101 may then save the calculated overall standard deviation of the plurality of tubes 11, 11, 12, 13.

Alternatively, with reference to FIG. 2, if sensors are not present on each of the tubes, or if other measurements are otherwise desired, obtaining the overall standard deviation of the plurality of tubes 10, 11, 12, 13 may include measuring an overall standard deviation of an upstream conduit 15 via an upstream sensor 25. The upstream conduit 15 may be upstream of any or all of the plurality of tubes 10, 11, 12, 13 and may thus feed any or all of the plurality of tubes 10, 11, 12, 13. Preferably, the upstream conduit 15 is upstream of and feeds each of the plurality of tubes 10, 11, 12, 13. Further, the upstream conduit 15 preferably feeds only the plurality of tubes 10, 11, 12, 13. The upstream sensor 25 may function similarly to the sensors 20, 21, 22, and 23. The sensed measurement may be transmitted from the upstream sensor 25 to the control system 101 where it may be saved as the overall standard deviation of the plurality of tubes 10, 11, 12, 13.

Similarly, if sensors are not present on each of the tubes, or if other measurements are otherwise desired, obtaining the overall standard deviation of the plurality of tubes 10, 11, 12, 13 may include measuring a overall standard deviation of a downstream conduit 16 via a downstream sensor 26. The downstream conduit 16 may be downstream of any or all of the plurality of tubes 10, 11, 12, 13 and thus any or all of the plurality of tubes 10, 11, 12, 13 may feed the downstream conduit 16. Preferably, the downstream conduit 16 is downstream of each of the plurality of tubes 10, 11, 12, 13, and each of the plurality of tubes 10, 11, 12, 13 feeds the downstream conduit 16. Further, the plurality of tubes 10, 11, 12, 13 preferably feeds only the downstream conduit 16. The downstream sensor 26 may function similarly to the sensors 20, 21, 22, 23, and 25. The sensed measurement may be transmitted from the upstream sensor 25 to the control system 101 where it may be saved as the overall standard deviation of the plurality of tubes 10, 11, 12, 13.

Step D may include determining whether the deviation change differs from the overall standard deviation by more than a predetermined limit Thus, once the first and second standard deviations and the overall standard deviation are stored in the control system 101, they can be retrieved and used for comparison. The control system 101 may determine whether the first standard deviation is larger than, smaller than, or essentially the same as the second standard deviation. Parameters may be selected such that small changes are deemed acceptable, but changes larger than the predetermined limit are deemed to be significant enough for an output. For example, if the deviation change is more than three times the overall standard deviation, output may be initiated.

Step E may include generating output indicating the flow status of the first tube 10, based on the comparison between the deviation change and the overall standard deviation. That output may include a display on a screen of the control system 101 of flow status, or the output may include an instruction from the control system 101 to another system or device to take action to change that flow status. Additionally, the flow status of the first tube may be stored in control system 101 or otherwise.

Determining whether the deviation change differs from the overall standard deviation by more than a predetermined limit may first involve determining whether the first standard deviation is larger or smaller than the second standard deviation. If the first standard deviation is significantly larger than the second standard deviation, the corresponding output may indicate that the flow status of the first tube is consistent with plugging. If the first standard deviation is significantly smaller than the second standard deviation, the corresponding output may indicate that the flow status of the first tube is consistent with a leak. If the first standard deviation is within a predetermined limit, the corresponding output may indicate that the flow status of the tube is normal.

The predetermined limit may be an absolute value or may be relative. For example, the predetermined limit may be met when the deviation change is at least three times the overall standard deviation (i.e., the predetermined limit is a factor of 3). If it is determined that the deviation change is significantly larger than the overall standard deviation (e.g., by a factor of 3), the output generated from the control system 101 may indicate that the flow status of the first tube 10 is consistent with plugging or a leak. Such indication by the control system 101 may include a warning light, a message on a display screen, or an instruction to one or more valves 50, 51 (FIG. 2). Such instruction may cause the valves 50, 51 to change position so as to adjust flow through the first tube 10 to accommodate the plugging or leak. More specifically, if a flow condition consistent with plugging is present because of a partial or complete blockage, other constriction, or other reduced flow, it may be desirable to route enhanced flow through the first tube 10 to try to push out the flow reducing matter. Or, it may be desirable to enhance efficiency by reducing flow through the first tube 10. Alternatively, if a flow condition consistent with a leak is present because of a hole, breach, or other enhanced flow, it may be desirable to restrict flow through the first tube 10 to try to eliminate loss. Or, it may be desirable to enhance flow through the first tube 10 to try to create an equilibrium condition.

If it is determined that the deviation change is within the threshold compared to the overall standard deviation (e.g., not more than three times), the output generated from the control system 101 may indicate that the flow status of the first tube is consistent with normal operation. Such indication by the control system 101 may include a message on a display screen, an instruction to one or more valves 50, 51 (FIG. 2), or simply a lack of a warning light or other indication of an event. As indicated above a flow status consistent with normal operation may indicate that the deviation change is not significant as compared to the overall standard deviation. Flow status consistent with normal operation may be indicated even if some deviation change is present, so long as that change is within defined limits

Any number of adjustments to operational parameters may occur in response to the flow status. As described above, the control system 101 may instigate changes to positions of valves 50, 51. Alternatively, adjustment may be made to the firing in the box to favor one pass over another. Other changes that can be used to mitigate or correct undesirable flow status include changes to temperature, flow rate, etc. Furthermore, processes may be employed to remediate the source of the undesirable flow status. For example, a steam-water decoking process, such as that described in U.S. Patent Publication 2010/0006478, may be used to improve flow through a plugged or partially plugged tube. Finally, the plugging or leak may be corrected by changing the makeup of the flow through the tubes. For example, when signs of plugging are present, the hydrocarbon content flowing through the tube 10 may be adjusted to slow or prevent further plugging.

While FIG. 1 illustrates steps A through E in a particular order, some steps may be modified and/or performed out of order. For example, steps B and C may occur simultaneously instead of step B occurring prior to step C. The simultaneous performance of steps B and C may be desirably when step C involves measurement from an upstream or downstream sensor 25, 26.

In some other embodiments, all measurements occur in real-time, and all calculations or other logical operations occur immediately after necessary measurements have occurred. Alternatively, calculations may occur after a predetermined number of measurements have been taken (e.g., at least 100) or after a predetermined amount of time has passed (e.g., 1 minute or less). Thus, measurements may be taken, and corresponding processing may occur periodically to generate an output indicating flow status. For example, measurements may occur continuously, with a flow status showing a trend being generated continuously. Alternatively, measurements may be taken periodically, with a flow status showing a trend being generated after a predetermined number of periods. In some instances, the output indicating flow status may be immediately generated after as few as two measurements (e.g., first sensor 20 and upstream sensor 25).

While the example above indicates a method of determining a flow status of the first tube 10, using various combinations of sensors 20, 21, 22, 23, 25, and 26, the methods described could be used to determine the flow status of any of a number of tubes associated with any of a number of measuring devices. Thus, for example, an olefin heater with dozens of tubes might have sensors on some or all of the tubes and flow status may be available for any of the tubes with sensors.

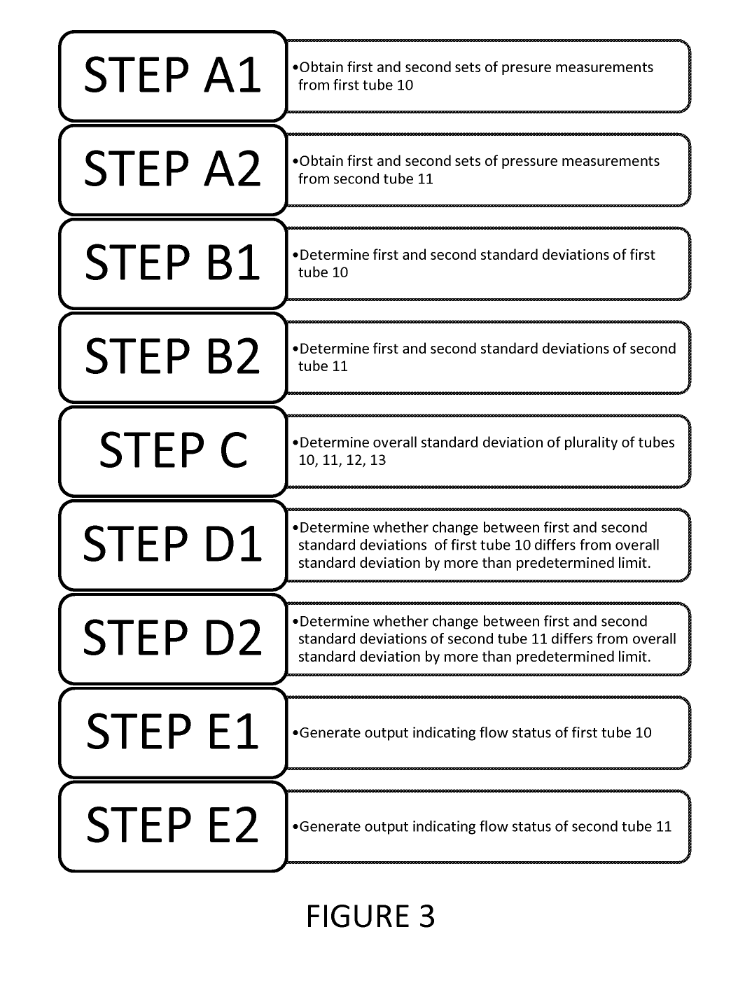

For example, as illustrated in FIG. 3, a method may provide a flow status of the second tube 11 using a method similar to that described above, including any variations between embodiments. Such method may include, in addition to steps A-E, steps of A2, B2, D2, and E2 of obtaining first and second sets of pressure measurements from the second tube over corresponding first and second periods of time, determining first and second standard deviations of the second tube 11, based on the first and second sets of pressure measurements from the second tube, comparing the first and second standard deviations of the second tube to get a deviation change of the second tube, determining whether the deviation change between first and second standard deviations of the second tube 11 differs from the overall standard deviation by more than the predetermined limit, and generating output indicating flow status of the second tube 11, respectively. In FIG. 3, steps A1, B1, D1, and E1 are identical to steps A, B, D, and E of FIG. 1. Similarly, steps A2, B2, D2, and E2 are nearly identical to steps A, B, D, and E of FIG. 1, with the difference being that they relate to the second tube 11 instead of the first tube 10. Notably, while the steps are shown as occurring in a particular order, certain steps may be performed out of order or simultaneously with the same result. Any number of measurements and outputs may be obtained by duplicating the elements of steps A, B, D, and E as indicated above.

The examples above illustrate the use of methods to indicate flow status over a particular period of time. However, additional measurements may be taken and recorded and used in additional calculations. Thus, the flow status of any of the tubes 10, 11, 12, 13 may be indicated over a second period in time, a third period in time, or any other period in time subsequent to the original period of time.

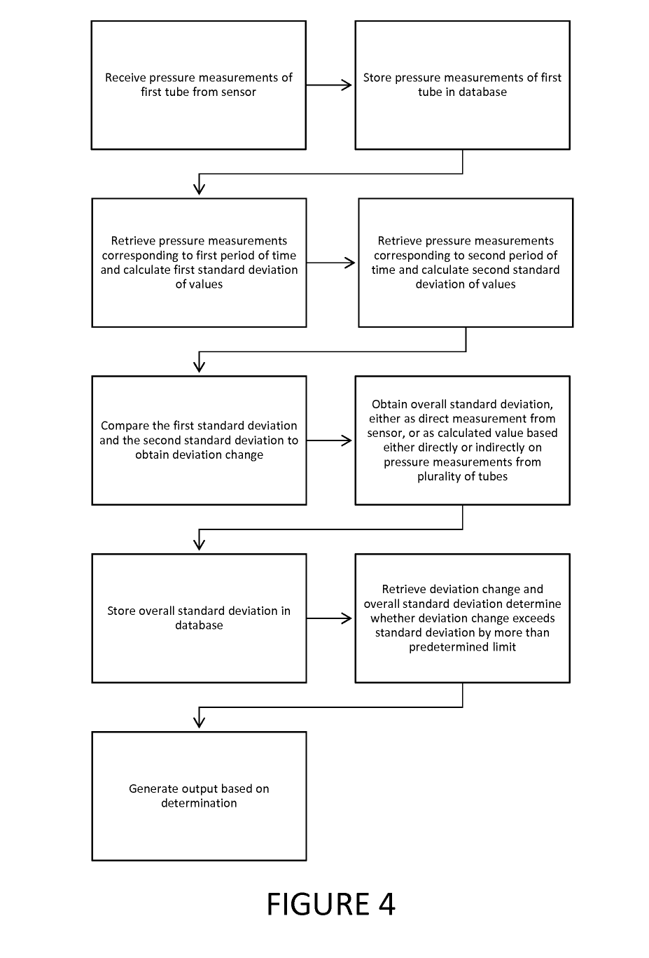

When the control system 101 is used, the following may occur, as illustrated in FIG. 4. The sensor 20 may periodically measure pressure of the first tube 10 and transmit the periodic pressure measurements of the first tube 10 to the control system 101. Similarly, the sensor 21 may periodically measure pressure of the second tube 11 and transmit the periodic pressure measurements of the second tube 11 to the control system 101. Additionally, the sensor 22 may periodically measure pressure of the third tube 12 and transmit the periodic pressure measurements of the third tube 12 to the control system 101. The transmissions of the first, second, and third sensors 20, 21, 22 may occur simultaneously or in turn. Once a particular pressure measurement has been transmitted, the control system 101 receives the measurement and may that pressure measurement and others in a database or otherwise. Thus, the control system 101 receives periodic pressure measurements from the first sensor 20, the second sensor 21, and the third sensor 22. From the received measurements, the control system 101 may calculate a first standard deviation, based on pressure measurements from the first sensor 20 over a period of time. If the measurements were stored previously, the control system 101 may retrieve stored pressure values of the first tube 10 and run a standard deviation calculation to determine a first standard deviation. Similarly, the control system 101 may calculate a second standard deviation, based on pressure measurements from the second sensor 21 over the period of time, optionally retrieving stored pressure values of the second tube 11 in the process. Likewise, the control system 101 may calculate a third standard deviation, based on pressure measurements from the third sensor 22 over the period of time, optionally retrieving stored pressure values of the third tube 12 in the process. The control system 101 may store the first standard deviation, the second standard deviation, and the third standard deviation in a database or otherwise. Once standard deviations have been calculated for a number of tubes 10, 11, 12, 13, the control system 101 may calculate an overall standard deviation based on the previously calculated standard deviations (e.g., the first standard deviation of the first tube and the first standard deviation of the second tube). Alternatively, the control system 101 may receive a value indicative of the overall standard deviation from another source (e.g., sensor 25 or sensor 26).

The control system 101 may then store the overall standard deviation in the database or otherwise. Once both the first standard deviation and the overall standard deviation have been determined, the control system 101 may determine whether the first standard deviation differs from the overall standard deviation by more than a predetermined limit This determination may involve retrieval from storage of the first standard deviation, the overall standard deviation, and/or the predetermined limit Similarly, once both the second standard deviation and the overall standard deviation have been determined, the control system 101 may determine whether the second standard deviation differs from the overall standard deviation by more than the predetermined limit This determination may involve retrieval from storage of the second standard deviation, the overall standard deviation, and/or the predetermined limit The control system 101 may then generate an output indicating a flow status of the first tube, the second tube, etc., based on the determination of whether the first, second, etc. standard deviation differs from the overall standard deviation by more than the predetermined limit While the steps are shown in a particular order, other ordering may also be used as indicated above.

Further, measurements indicated above may be taken after various passages of time. Thus, the first period of time may be very near the second period of time and the third period of time may immediately follow the second period of time such that measurements are substantially continuous. In such an embodiment, an nth measurement may be compared with a baseline measurement to show an overall change in condition while an nth measurement may be compared with a closer measurement to show an incremental change

In some instances, it may be acceptable to take fewer measurements. While more measurements are usually considered preferable to fewer measurements, if the measurements provide better data, fewer measurements may be suitable. Thus, for example, where many direct pressure measurements might be necessary to provide a pressure reading for the first tube 10 to a suitable level of confidence when noise is present, fewer indirect pressure measurements may provide the same degree of confidence if the noise can be eliminated. Likewise, by calculating change to standard deviation, the impact of the noise on the readings may be effectively measured and tracked, allowing for a much greater degree of confidence with the same number of readings. Similarly, the same degree of confidence may be present with fewer readings.

Whether the same degree of confidence can be reached or not, it may be preferable to take fewer measurements. For example, if any of sensors 20, 21, 21, 22, 23, 25, 26 are wireless sensors, it may be desirable to transmit to the control system 101 less frequently to conserve battery life. Thus, with reduced transmissions, it may also be desirable to take less frequent measurements than if hard wired sensors were used with a continuous power supply. By taking fewer measurements and requiring fewer transmissions, wireless sensors may be used where only hard wired sensors were previously practicable. Further, where battery powered sensors may have been used, smaller sensors may be used because fewer transmissions would require less battery reserve and such reduced reserve may be provided in the form of a smaller battery.

The example above contemplates determining first standard deviation and overall standard deviation and comparing those numbers to determine flow status. However, it should be understood that even if these exact calculations are not used, variations may be used to arrive at the same outcome.

Thus, most broadly, the method includes obtaining a noise parameter of a first tube of a plurality of tubes of an olefin heater; obtaining a noise parameter of the plurality of tubes; and using the noise parameter of the first tube and the noise parameter of the plurality of tubes to determine whether a flow status of the first tube is consistent with plugging, consistent with a leak, or consistent with normal operation. It may be useful to determine whether the change in noise of the first tube represents an increase or a decrease relative to the change in noise of the plurality of tubes. This may provide the complete picture as to whether the noise of the first tube is increasing or decreasing as compared with expectations. The methods of making the determinations in the broad method can include the specific examples above, or can use other mathematically equivalent calculations to arrive at the flow status indication described in detail above.

Those of skill in the art will appreciate that many modifications and variations are possible in terms of the disclosed embodiments, configurations, materials, and methods without departing from their scope. Accordingly, the scope of the claims and their functional equivalents should not be limited by the particular embodiments described and illustrated, as these are merely exemplary in nature and elements described separately may be optionally combined.

1. A method of indicating flow status of a first tube of a plurality of tubes of an olefin heater, comprising:
a. obtaining a first set of pressure measurements from the first tube over a period of time;
b. determining a first standard deviation of the first tube, based on the first set of pressure measurements;
c. obtaining a second set of pressure measurements from the first tube over a second period of time;
d. determining a second standard deviation of the first tube, based on the second set of pressure measurements;
e. comparing the first standard deviation and the second standard deviation to get a deviation change;
f. determining an overall standard deviation of the plurality of tubes;
g. determining whether the deviation change differs from the overall standard deviation by more than a predetermined limit;
h. responsive to a determination that the deviation change differs from the overall standard deviation by more than the predetermined limit, generating output indicating a flow status of the first tube.

2. The method of claim 1, further comprising adjusting an operational parameter in response to the flow status.

3. The method of claim 1, wherein the first and second periods of time are each 1 minute or less, and wherein the first and second sets of pressure measurements each comprises at least 100 pressure measurements.

4. The method of claim 1, wherein comparing the first standard deviation and the second standard deviation comprises determining whether the first standard deviation is larger or smaller than the second standard deviation.

5. The method of claim 1, wherein the predetermined limit comprises a factor of three.

6. The method of claim 5, wherein, if the first standard deviation is larger than the second standard deviation, generating output comprises indicating that the flow status of the first tube is consistent with plugging; and wherein, if the first standard deviation is smaller than the second standard deviation, generating output comprises indicating that the flow status of the first tube is consistent with a leak.

7. The method of claim 1, further comprising:
a. obtaining a first set of pressure measurements from a second tube over the first period of time;
b. determining a first standard deviation of the second tube, based on the first set of pressure measurements from the second tube;
c. obtaining a second set of pressure measurements from the second tube over the second period of time;
d. determining a second standard deviation of the second tube, based on the second set of pressure measurements from the second tube;
e. comparing the first and second standard deviations of the second tube to get a deviation change of the second tube;
f. determining whether the deviation change of the second tube differs from the overall standard deviation by more than the predetermined limit;
g. responsive to a determination that the deviation change of the second tube differs from the overall standard deviation by more than the predetermined limit, generating output indicating a flow status of the second tube.

8. The method of claim 7, wherein determining the overall standard deviation comprises determining a standard deviation of the values of the first standard deviation of the first tube and the first standard deviation of the second tube.

9. The method of claim 1 further comprising:
a. storing the deviation change;
b. storing the overall standard deviation;
c. storing the predetermined limit; and
d. retrieving the deviation change and overall standard deviations prior to determining whether the deviation change differs from the overall standard deviation by more than a predetermined limit.

10. A method comprising:
a. obtaining a noise parameter of a first tube of a plurality of tubes of an olefin heater;
b. obtaining a noise parameter of the plurality of tubes; and
c. using the noise parameter of the first tube and the noise parameter of the plurality of tubes, determining whether a flow status of the first tube is consistent with plugging, consistent with a leak, or consistent with normal operation.

11. A system for indicating flow status of a first tube of an olefin heater, comprising:
a. a first sensor configured to periodically measure pressure of the first tube and transmit the periodic pressure measurements to a control system;
b. a second sensor configured to periodically measure pressure of a second tube and transmit the periodic pressure measurements to the control system;
c. a third sensor configured to periodically measure pressure of a third tube and transmit the periodic pressure measurements to the control system;
d. a control system configured to
i. receive the periodic pressure measurements from the first sensor,
ii. calculate a first standard deviation change, based on pressure measurements from the first sensor over a period of time,
iii. receive the periodic pressure measurements from the second sensor,
iv. calculate a second standard deviation change, based on pressure measurements from the second sensor over the period of time,
v. receive the periodic pressure measurements from the third sensor,
vi. calculate a third standard deviation change, based on pressure measurements from the third sensor occurring over the period of time,
vii. calculate an overall standard deviation, based on the periodic pressure measurements from the first sensor, the second sensor, and the third sensor,
viii. determine whether the first standard deviation change differs from the overall standard deviation by more than a predetermined limit, and
ix. generate an output indicating a flow status of the first tube, based on the determination of whether the first standard deviation change differs from the overall standard deviation by more than the predetermined limit.

12. The system of claim 11, further comprising:
a plurality of additional sensors configured to periodically measure pressure of a corresponding plurality of additional tubes and transmit the periodic pressure measurements to the control system;
wherein the control system is further configured to
i. receive the periodic pressure measurements from the plurality of additional sensors, and
ii. calculate a plurality of additional standard deviation changes, based on pressure measurements from the plurality of additional sensors occurring over the period of time; and
wherein the overall standard deviation calculation is further based on the periodic pressure measurements of the additional sensors.
